(19) United States
(12) Patent Application Publication
(10) Pub. No.: US 2008/0064466 A1
(43) Pub. Date: Mar. 13, 2008

(54) SLOT MACHINE WITH PAYOUT BASED ON SYMBOLS ON TRACK OF CHARACTER MOVEMENT AND PLAYING METHOD THEREOF

(75) Inventor: Hiroki Saito, Tokyo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Aruze Corp., Koto-ku (JP)

(21) Appl. No.: 11/841,246

(22) Filed: Aug. 20, 2007

(30) Foreign Application Priority Data
Sep. 8, 2006 (JP) 2006-244159

(51) Int. Cl. A63F 13/00

(52) U.S. Cl. 463/16; 463/20

(57) ABSTRACT

In the case of rearrangement of a plurality of symbols arranged in each of a plurality of display area provided in a matrix pattern in a liquid crystal display unit, a dynamic character image is moved on the respective display areas from a start display part to a goal display part. When the dynamic character image has reached the goal display part, a payout to a player is set according to one of the number of the symbols and a combination of the symbols on a track of movement of the dynamic character image.

### CROSS REFERENCE TO RELATED APPLICATIONS

This application is based upon and claims the benefit of priority from the prior Japanese Patent Application No. 2006-244159, filed on Sep. 8, 2006, the entire contents of which are incorporated herein by reference.

### BACKGROUND OF THE INVENTION

1. Field of the Invention

The present invention relates to a slot machine on which a player plays a game, and a method for playing the same. More particularly, the present invention relates to a slot machine which sets paylines for providing payouts in a creative manner, and a playing method thereof.

2. Description of the Related Art

A relevant slot machine includes a plurality of display areas provided in a matrix pattern. A plurality of symbols are automatically rearranged in the plurality of display areas, and a payout is provided according to the kinds of the symbols rearranged on a payline. The payline is generally set to be a straight line in a horizontal direction or an oblique direction of the plurality of display areas. However, in recent years, as disclosed in U.S. Pat. No. 6,093,102 and U.S. Pat. No. 6,960,133, a slot machine having various nonlinear paylines and a slot machine which is irrelevant to even the concept of the payline have been proposed.

However, in the above slot machines disclosed in U.S. Pat. No. 6,093,102 and U.S. Pat. No. 6,960,133, a payout is provided when a predetermined number of symbols are displayed in a plurality of display areas provided in a matrix pattern. In this regard, as a result, the same display mode as that of the conventional slot machine is employed.

### SUMMARY OF THE INVENTION

The present invention is made to solve the conventional problems described above. It is an object of the present invention to provide a slot machine which provides new entertainment properties by using a track of a dynamic character image as a payline to set a payout.

The first aspect of the present invention is a slot machine comprising: a display having a rectangular display part in which a plurality of display areas are provided in a matrix pattern, and in which one of a plurality of symbols is arranged or rearranged in each of the plurality of display areas, and capable of displaying in the display part a character image moving across the plurality of display areas; and a controller configured to (a) automatically rearrange the symbols in at least some of the plurality of display areas, (b) display the character image moving across the plurality of display areas when the rearrangement is at least partially completed, and (c) set a payout according to one of a number and a combination of the symbols displayed on a track of movement of the character image.

According to the first aspect of the present invention, it is possible to provide a novel slot machine in which individual symbols are rearranged in the plurality of display areas in the display part, respectively, and in which movement of the character image is started on the rearranged symbols. Moreover, an award is set according to the number or a combination of the symbols on which the character image is superimposed and displayed while being moved. In other words, since the award is determined by the number of the symbols on which the character image passes, it is possible to make a player more enthusiastic about a game by making him/her interested in the number of the symbols on which the character image passes. Moreover, since the award is determined by a combination of the symbols on which the character image is superimposed and displayed, the track of movement of the character image plays the same role as the so-called conventional payline. Consequently, it is possible to realize a creative method compared with a conventional standardized method of determining a payline. In addition, it is also possible to add an incidental entertainment such as that the player can visually recognize a formation process of a payline determined by movement of the character image.

The second aspect of the present invention is a slot machine comprising: a display in which at least the following five display parts can be formed, including a display part having a rectangular shape, in which a plurality of display areas are provided in a matrix pattern, and in which one of a plurality of symbols is arranged or rearranged in each of the display areas, a start display part and a goal display part which are positioned adjacent to one of two opposite sides of the display part, the start display part in which a character image before movement is arranged, the goal display part being a goal to be reached by the character image having started to move from the start display part, and an upper return display part and a lower return display part which are positioned adjacent to the other two sides of the display part, the sides being adjacent to neither the start display part nor the goal display part, and in which fourth symbols are arranged, the fourth symbols indicating moving directions of the character image to the display part for returning the character image into the display part when the character image moving in the display part has moved to the outside of the other two sides, wherein the plurality of symbols displayed in the plurality of display areas include: first symbols indicating moving directions of the character image; second symbols related to payouts; and third symbols stopping movement of the character image; and a controller configured to (a) randomly and automatically rearrange any of the first, second and third symbols in each of the display areas, (b) start the character image to move from the start display part to the goal display part through the display part along the first symbols in any one of cases where rearrangement of the symbols is all completed and where rearrangement of the symbols in the display areas adjacent to the start display part is completed, (c) return the character image into the display part along the fourth symbols when the character image moving in the display part has moved to the upper return display part or the lower return display part from the other two sides of the display part, and (d) set a payout according to one of a number and a combination of the symbols displayed on a track of movement of the character image.

According to the second aspect of the present invention, it is possible to provide a novel slot machine in which individual symbols are rearranged in the plurality of display areas in the display part, respectively, and in which movement of the character image on the rearranged symbols is started from the start display part provided adjacent to one of the sides of the rectangular display part. Moreover, whether or not to provide an award is set according to the number or a combination of the symbols on which the character image is superimposed and displayed while being moved before the character image reaches the goal display part provided adjacent to the opposite side.

Moreover, when the character image is moved to the upper return display part and the lower return display part outside of the display part, the character image moved to the outside of the display part is set to be returned to the display part. Thus, a range of movement of the character image is extended. Consequently, an effect of movement of the character image can be made more dynamic.

Furthermore, the symbols include the first symbols indicating movement of the predetermined character image and the third symbols which stop the movement of the character image, besides the second symbols related to whether or not to provide an award. Moreover, the above symbols are randomly rearranged in the display areas in the display part. Thus, the player can find additional excitement of predicting movement of the character image by following the first and third symbols with his/her eyes before the movement of the character image is started.

The third aspect of the present invention is a method for playing a slot machine, comprising the steps of: (a) rearranging, by a controller, a plurality of symbols in a rectangular display part in which a plurality of display areas are provided in a matrix pattern, and in which one of the plurality of symbols is arranged or rearranged in each of the display areas, on a display; (b) displaying, by the controller, a character image moving across the plurality of display areas when the rearrangement is at least partially completed; and (c) setting, by the controller, a payout according to one of a number and a combination of the symbols displayed on a track of movement of the character image.

According to the third aspect of the present invention, it is possible to provide a novel slot machine in which individual symbols are rearranged in the plurality of display areas in the display part, respectively, and in which movement of the character image is started on the rearranged symbols. Moreover, an award is set according to the number or a combination of the symbols on which the character image is superimposed and displayed while being moved. In other words, since the award is determined by the number of the symbols on which the character image passes, it is possible to make a player more enthusiastic about a game by making him/her interested in the number of the symbols on which the character image passes. In addition, since the award is determined by a combination of the symbols on which the character image is superimposed and displayed, the track of movement of the character image plays the same role as the so-called conventional payline. Consequently, it is possible to realize a creative method compared with a conventional standardized method of determining a payline. Moreover, it is also possible to add an incidental entertainment such as that the player can visually recognize a formation process of a payline determined by movement of the character image.

The fourth aspect of the present invention is a method for playing a slot machine, comprising the steps of (a) forming, by a controller, at least the following five display parts on a display, including a display part having a rectangular shape, in which a plurality of display areas are provided in a matrix pattern, and in which one of a plurality of symbols is arranged or rearranged in each of the display areas, a start display part and a goal display part which are positioned adjacent to one of two opposite sides of the display part, the start display part in which a character image before movement is arranged, the goal display part being a goal to be reached by the character image having started to move from the start display part, and an upper return display part and a lower return display part which are positioned adjacent to the other two sides of the display part, the sides being adjacent to neither the start display part nor the goal display part, and in which fourth symbols are arranged, the fourth symbols indicating moving directions of the character image to the display part for returning the character image into the display part when the character image moving in the display part has moved to the outside of the other two sides; (b) randomly and automatically rearranging, by the controller, in the respective display areas in the display part, any of first, second and third symbols included in the plurality of symbols displayed in the plurality of display areas, the first symbols indicating moving directions of the character image, the second symbols related to payouts and the third symbols stopping movement of the character image; (c) starting, by the controller, the character image to move from the start display part to the goal display part through the display part along the first symbols in any one of cases where rearrangement of the symbols is all completed and where rearrangement of the symbols in the display areas adjacent to the start display part is completed; (d) returning, by the controller, the character image into the display part along the fourth symbols when the character image moving in the display part has moved to the upper return display part or the lower return display part from the other two sides of the display part; and (e) setting, by the controller, a payout according to one of a number and a combination of the symbols displayed on a track of movement of the character image.

According to the fourth aspect of the present invention, it is possible to provide a novel slot machine in which individual symbols are rearranged in the plurality of display areas in the display part, respectively, and in which movement of the character image on the rearranged symbols is started from the start display part provided adjacent to one of the sides of the rectangular display part. Moreover, whether or not to provide an award is set according to the number or a combination of the symbols on which the character image is superimposed and displayed while being moved before the character image reaches the goal display part provided adjacent to the opposite side.

Moreover, when the character image is moved to the upper return display part and the lower return display part outside of the display part, the character image moved to the outside of the display part is set to be returned to the display part. Thus, a range of movement of the character image is extended. Consequently, an effect of movement of the character image can be made more dynamic.

Furthermore, the symbols include the first symbols indicating movement of the predetermined character image and the third symbols which stop the movement of the character image, besides the second symbols related to whether or not to provide an award. Moreover, the above symbols are randomly rearranged in the display areas in the display part. Thus, the player can find additional excitement of predicting movement of the character image by following the first and third symbols with his/her eyes before the movement of the character image is started.

### BRIEF DESCRIPTION OF THE DRAWINGS

FIG. 1 is a flowchart showing operations related to a method for playing a slot machine according to an embodiment of the present invention.

FIG. 2 is a perspective view showing an external appearance of the slot machine according to the embodiment of the present invention.

FIG. 3 is an explanatory view showing symbols displayed in each display area in the slot machine according to the embodiment of the present invention.

FIG. 4 is an explanatory view showing winning combinations for which payouts are provided and the number of coins to be paid out for each of the winning combinations made in the slot machine according to the embodiment of the present invention.

FIG. 5 is a block diagram showing a control circuit in the slot machine according to the embodiment of the present invention.

FIG. 6 is a flowchart showing procedures of authentication processing executed in the slot machine according to the embodiment of the present invention.

FIG. 7 is a flowchart showing procedures of basic game execution processing executed in the slot machine according to the embodiment of the present invention.

FIG. 8 is a flowchart showing procedures of stop-symbol determination processing executed in the slot machine according to the embodiment of the present invention.

FIG. 9 is a flowchart showing procedures of symbol-scroll control processing executed in the slot machine according to the embodiment of the present invention.

FIG. 10 is a view showing the position of each display part in a liquid crystal display unit and stop-symbols stopped in the respective display areas in the slot machine according to the embodiment of the present invention.

FIG. 11 is a view showing a state where dynamic character images are positioned in one of the display parts and symbols are scroll-displayed in one of the other display parts.

FIG. 12 is a view showing a state where symbols in a column 28b are stopped and the dynamic character images are moved to stop-symbols in a column 28a.

FIG. 13 is a view showing a state where symbols in a column 28c are stopped and the dynamic character images are moved to the stop-symbols in the column 28b.

FIG. 14 is a view showing a state where symbols in a column 28e are stopped and one of the dynamic character images has reached a goal display part.

FIG. 15 is a view showing a track of movement of the dynamic character image that has reached the goal display part.

FIG. 16 is an explanatory view showing the plurality of display parts and the like in the slot machine according to the embodiment of the present invention.

### DETAILED DESCRIPTION OF THE EMBODIMENT

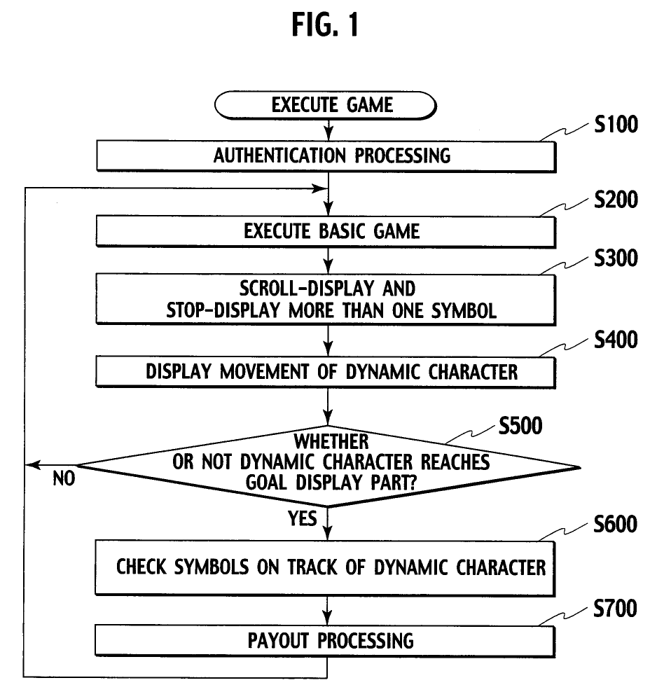

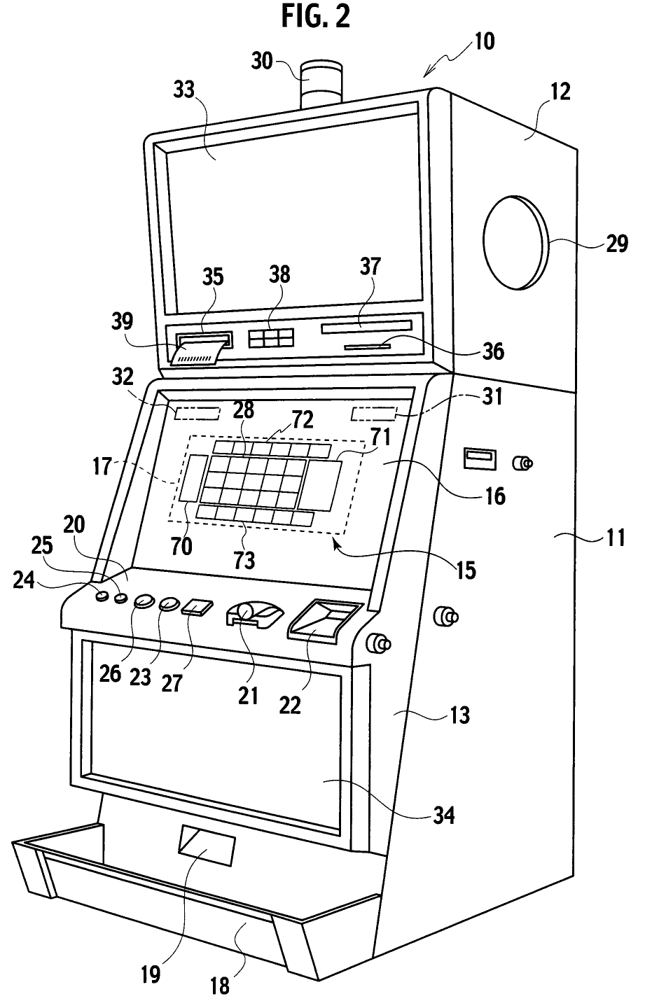

With reference to the drawings, a slot machine according to an embodiment of the present invention will be described below. FIG. 1 is a flowchart schematically showing operations related to a method for playing the slot machine according to the embodiment of the present invention. With reference to the flowchart shown in FIG. 1 and a perspective view shown in FIG. 2, description will be given below of schematic operations of the slot machine and the method for playing the slot machine according to the embodiment of the present invention.

In the slot machine according to the embodiment of the present invention, when a power is turned on to start the slot machine, authentication processing is first performed (Step S100). In the authentication processing, initial checking before a basic game (unit game) is started is carried out, such as whether or not a program for operating a system is normally run and whether or not the program has been altered.

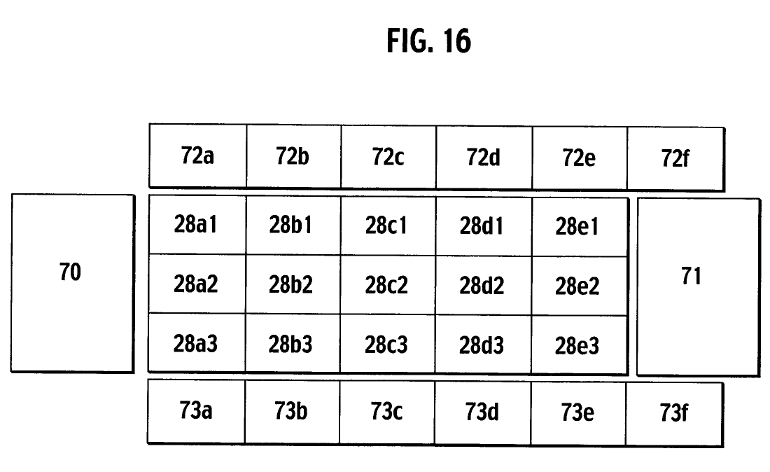

Next, the basic game is executed (Step S200). In the front surface of a cabinet 11, a display window 15 is provided (see FIG. 2). In a liquid crystal display unit 17 that is an inside of the display window 15, a rectangular display part 28 is provided, which includes 5 columns×3 rows, a total of 15 display areas 28a1 to 28e3, in a matrix pattern (see FIGS. 2 and 16). In the respective display areas 28a1 to 28e3, symbols are displayed (arranged), respectively (see FIGS. 10 to 16). As shown in FIGS. 10 to 16, a start display part 70 from which a dynamic character image (a frog character image in this embodiment) X that is a character image starts moving is provided adjacent to the left side of the rectangular display part 28. Moreover, a goal display part 71 which the dynamic character image X reaches is provided adjacent to the right side of the rectangular display part 28. Furthermore, as shown in FIGS. 10 to 16, an upper return-symbol display part 72 which returns to the display part 28 the dynamic character image X that has moved to above the display part 28 is provided adjacent to the upper side of the rectangular display part 28. Moreover, a lower return-symbol display part 73 which returns to the display part 28 the dynamic character image X that has moved to below the display part 28 is provided adjacent to the lower side of the rectangular display part 28. The symbols include: moving direction indicator symbols (first and fourth symbols) Y indicating only moving directions of the dynamic character image X; symbols (second symbols) W related to payouts; and trap symbols (third symbols) Z which stop movement of the dynamic character image X. Here, in this embodiment, the symbols W related to payouts include the moving direction indicator symbols Y. In the upper return-symbol display part 72 and the lower return-symbol display part 73, the moving direction indicator symbols (the fourth symbols) Y for returning the dynamic character image X to the display part 28 and the trap symbols (the third symbols) Z are fixed and displayed. In this embodiment, the dynamic character image X itself moves across the display part 28 with movement in a form of a dynamic image. However, without being limited thereto, a static character image without movement can also be adopted for the dynamic character image X.

As described above, the trap symbols Z in the upper return-symbol display part 72 and the lower return-symbol display part 73 correspond to the third symbols, and the moving direction indicator symbols Y therein correspond to the fourth symbols. In this embodiment, adopted is a system in which the trap symbols Z, which are the third symbols, and the moving direction indicator symbols Y, which are the fourth symbols, are constantly fixed and displayed. However, without being limited thereto, the third and fourth symbols may be rearranged for each unit game. In this case, changes in arrangement and the number of the third and fourth symbols by rearrangement make it possible to avoid a situation where it is obvious that the dynamic character image X reaches the goal display part 71, that is a goal, before movement of the dynamic character image X is started or completed. Thus, diversity of the game can be secured.

In this embodiment, the trap symbols Z are arranged in all of the upper return-symbol display part 72, the lower return-symbol display part 73 and the display areas 28a1 to 28e3 in the display part 28. However, it is possible to arbitrarily set whether or not to arrange the trap symbols Z in the respective display parts described above and how many trap symbols Z are to be arranged therein.

As to the display areas 28a1 to 28e3, suffixes “a to e” attached to the reference numeral “28” represent columns, and suffixes “1 to 3” attached thereto represent rows (see FIG. 16).

In the basic game, when a spin button 23 is pressed in a state where a desired number of credits are bet by throwing coins into a coin receiving port 21 or the like, the symbols displayed in the respective display areas 28a1 to 28e3 start to be scroll-displayed, and are then automatically stopped sequentially from those in the leftmost column 28a (Step S300). Specifically, the symbols are stopped at predetermined time intervals sequentially from the symbols in the leftmost column 28a to the symbols in the columns 28b, 28c, 28d and 28e in this order.

When the symbols in all the columns 28a to 28e are automatically stopped, first, a plurality of aforementioned dynamic character images X are displayed so as to move to the stopped symbols in the leftmost column 28a from the start display part 70 from which a dynamic character image X starts moving. Thereafter, the dynamic character images X are displayed so as to move sequentially from the column 28a to the column 28b, from the column 28b to the column 28c, from the column 28c to the column 28d, from the column 28d to the column 28e and from the column 28e to the goal display part 71 (Step S400). Here, the symbol display areas on which the dynamic character images X are displayed in the manner of being superimposed on the stopped symbols are displayed brighter than the other display areas by use of a backlight and the like, for example. Thus, a different display mode is set for the display areas so as to be easily recognizable to a player. As means for setting a different display mode, various means are conceivable, such as display in special colors, other than the backlight.

Specifically, in this embodiment, character images of three frogs (hereinafter referred to as frog character images X) as the plurality of dynamic character images X disappear from the start display part 70 when the symbols in all the columns 28a to 28e are stopped, and are then displayed so as to be superimposed on the stopped symbols in the leftmost column 28a. Thereafter, the frog character images X are superimposedly displayed sequentially from the column 28a to the column 28b, from the column 28b to the column 28c, from the column 28c to the column 28d, from the column 28d to the column 28e and from the column 28e to the goal display part 71.

In the case where the stopped symbols in the columns 28a to 28e are the moving direction indicator symbols Y consisting of arrows (also including the symbols W including the moving direction indicator symbols Y), the frog character images X displayed in the manner of being superimposed on the symbols are displayed so as to move to the stopped symbols in the next column 28b in directions indicated by the arrows of the moving direction indicator symbols Y. Specifically, in this embodiment, the frog character images X in the leftmost column 28a disappear from the column 28a when the symbols in the next column 28b are stopped, and are displayed so as to be superimposed on the stopped symbols in the next column 28b.

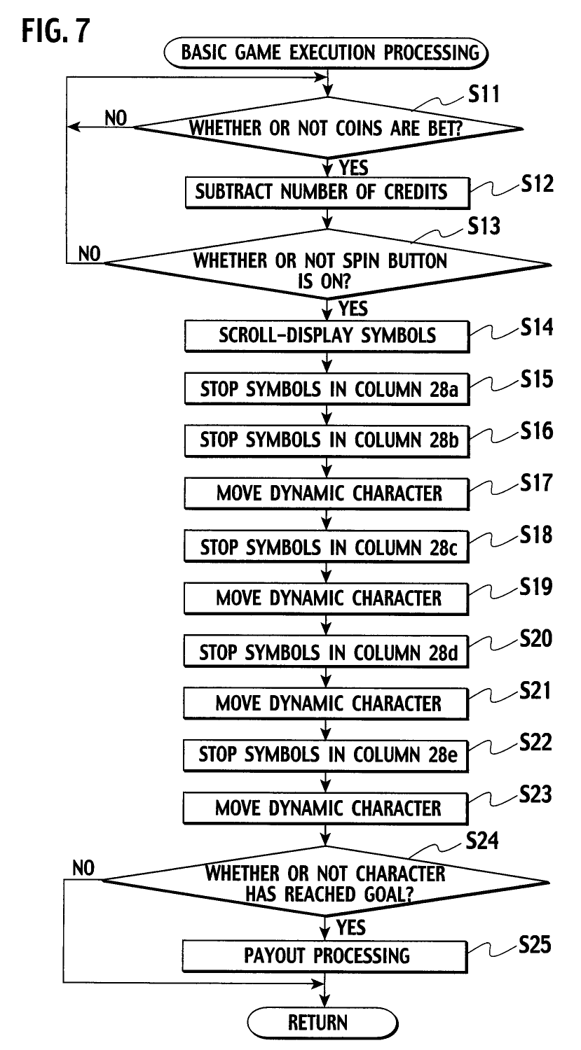

The above operation of moving the frog character images X will be described in detail later with reference to FIG. 7.

When any of the stopped symbols in the leftmost column 28a is a trap symbol Z consisting of a character of “snake”, the frog character image X displayed so as to be superimposed on the trap symbol Z is made to disappear as if the frog is eaten by the snake.

After the symbols in the last column 28e are stopped, it is determined whether or not the frog character images X have reached the goal display part (goal) 71 to be reached by the frog character images X (Step S500).

When there is a frog character image X reached the goal display part (goal) 71, the symbols on a track of movement of the frog character image X are confirmed (Step S600). Thereafter, coins are paid out according to the number of the frog character images X that have reached the goal display part (goal) 71 and the number of the symbols on which the frog character images X are superimposed and displayed. Moreover, coins are paid out according to types of winning combinations.

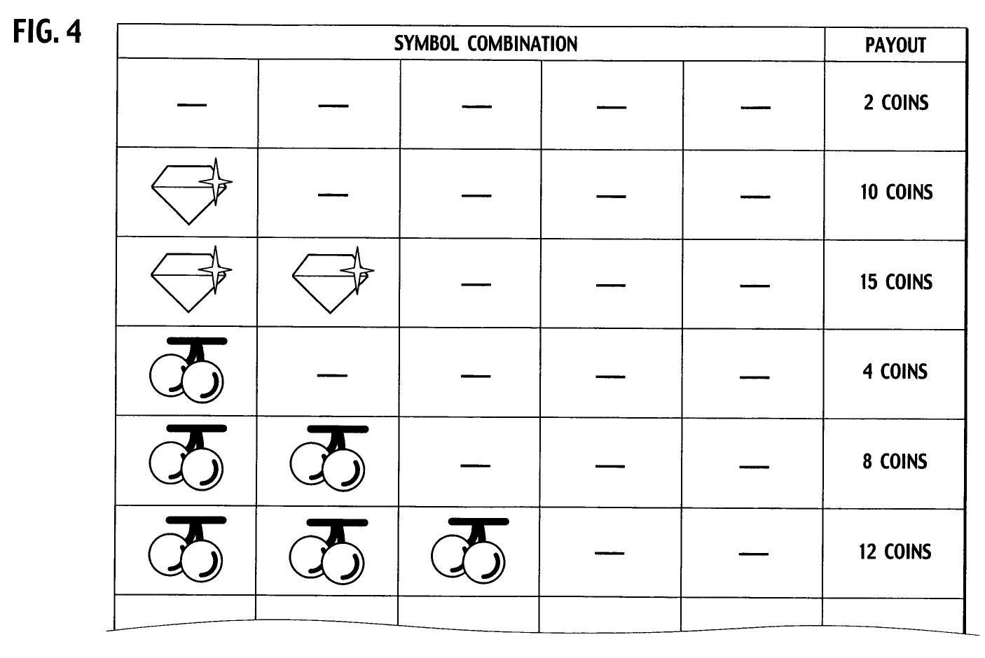

For example, in the case where one “diamond” symbol that is the symbol W related to a payout exists on the track of movement of the frog character image X, 10 coins are paid out for 1 BET (see FIG. 4). Accordingly, the track of movement of the frog character image X as the predetermined character image serves as a payline. For example, when the “diamond” as the second symbol that is the symbol W related to the payout (award) exists on the payline, a predetermined number of credits are provided as the payout. Such a payout of credits may be a physical payout of coins or may be controlled so as to electronically add a count value to a memory provided in the slot machine.

Here, the track of movement of the frog character image X serves as the payline.

After predetermined symbols are confirmed as the symbols on any of the tracks of movement of the frog character images X, coins are paid out according to the number of the frog character images X that have reached the goal display part (goal) 71 and the number of the symbols on which the frog character images X are superimposed and displayed. Moreover, coins are paid out according to the types of winning combinations (Step S700).

Although the above description was given of the example of displaying the “frog” image as the dynamic character image X for attracting the player's attention, other images may be displayed.

Next, with reference to the perspective view shown in FIG. 2, description will be given of a configuration of a slot machine 10 according to the embodiment of the present invention.

The slot machine 10 is placed in a game arcade. In the slot machine 10, coins, bills or valuable electronic information equivalent thereto are used as game media for executing a unit game. Note, however, that the game media are not particularly limited in the present invention. For example, medals, tokens, electronic money and tickets can be cited. The tickets described above are not particularly limited. For example, bar-coded tickets as described later and the like can be cited.

As shown in FIG. 2, the slot machine 10 includes the cabinet 11, a top box 12 provided on the cabinet 11, and a main door 13 provided on the front surface of the cabinet 11.

Inside the cabinet 11, the liquid crystal display unit 17 (display) is provided, which scrolls a plurality of symbols inside the display window 15 made of a transparent material. The liquid crystal display unit 17 includes the display part 28. The display part 28 includes 5 columns×3 rows, a total of 15 display areas 28a1 to 28e3 in a matrix pattern for displaying the symbols (see FIG. 16). Thus, the symbols displayed in the display part 28 are made visible to a player through the display window 15. The start display part 70 from which the dynamic character image X starts moving is provided adjacent to the left side of the rectangular display part 28. Moreover, the goal display part 71 which the dynamic character image X reaches is provided adjacent to the right side of the rectangular display part 28 (see FIGS. 10 to 16). Furthermore, the upper return-symbol display part 72 which returns to the display part 28 the dynamic character image X that has moved to above the display part 28 is provided adjacent to the upper side of the rectangular display part 28. Moreover, the lower return-symbol display part 73 which returns to the display part 28 the dynamic character image X that has moved to below the display part 28 is provided adjacent to the lower side of the rectangular display part 28 (see FIGS. 10 to 16).

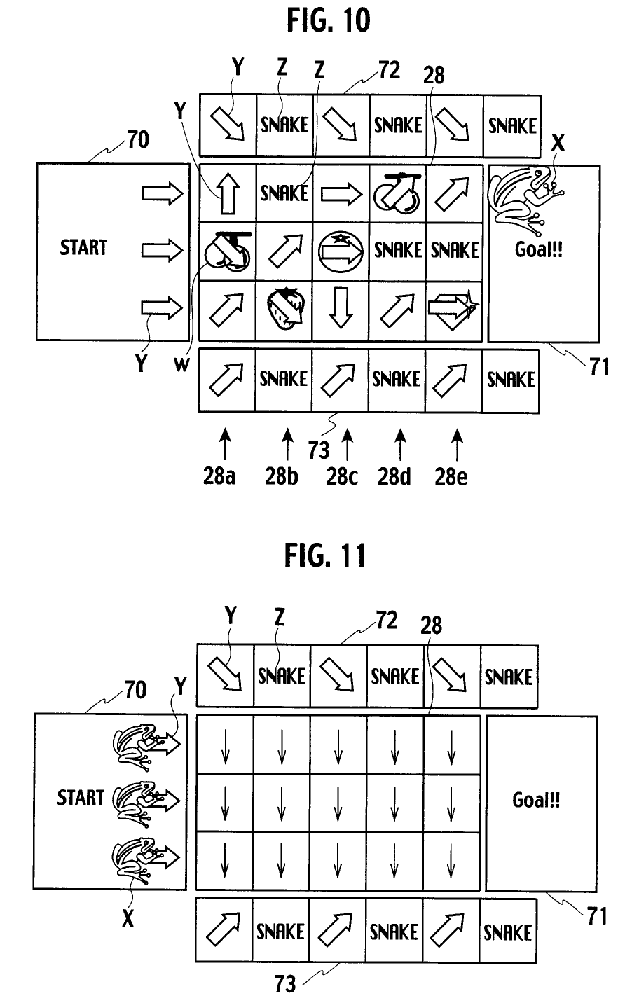

In this embodiment, when the basic game is executed, the symbols displayed in the respective display areas 28a1 to 28e3 in 5 columns×3 rows start to be scrolled (see FIG. 11).

In this embodiment, as the display, the display areas 28a1 to 28e3 in 5 columns×3 rows in the liquid crystal display unit 17 are cited as an example. However, the present invention is not limited thereto.

In front of the liquid crystal display unit 17 in the main door 13, a lower image display panel 16 is provided. The lower image display panel 16 includes a transparent liquid crystal panel and displays various information about games, effect images and the like during the games.

In the lower image display panel 16, a credit number display part 31 and a payout number display part 32 are provided. In the credit number display part 31, the number of coins credited is displayed by an image. In the payout number display part 32, the number of coins to be paid out when a winning combination to be described later is established is displayed by an image.

The winning combination is a combination of symbols, for example, when predetermined symbols exist on a track of movement of the frog character image X. When such a winning combination stops within the display part 28, a set number of coins are paid out. Thus, the track of movement of the frog character image X serves as a payline. The number of coins to be paid out is increased as the BET number is increased. For example, if the number of coins to be paid out is 5 when the BET number is 1, coins are to be paid out when the BET number is 2.

On the lower image display panel 16, the display window 15 is provided, through which the respective symbols displayed in the display areas 28a1 to 28e3 in 5 columns×3 rows in the liquid crystal display unit 17 provided inside the lower image display panel 16 are made visible to the player.

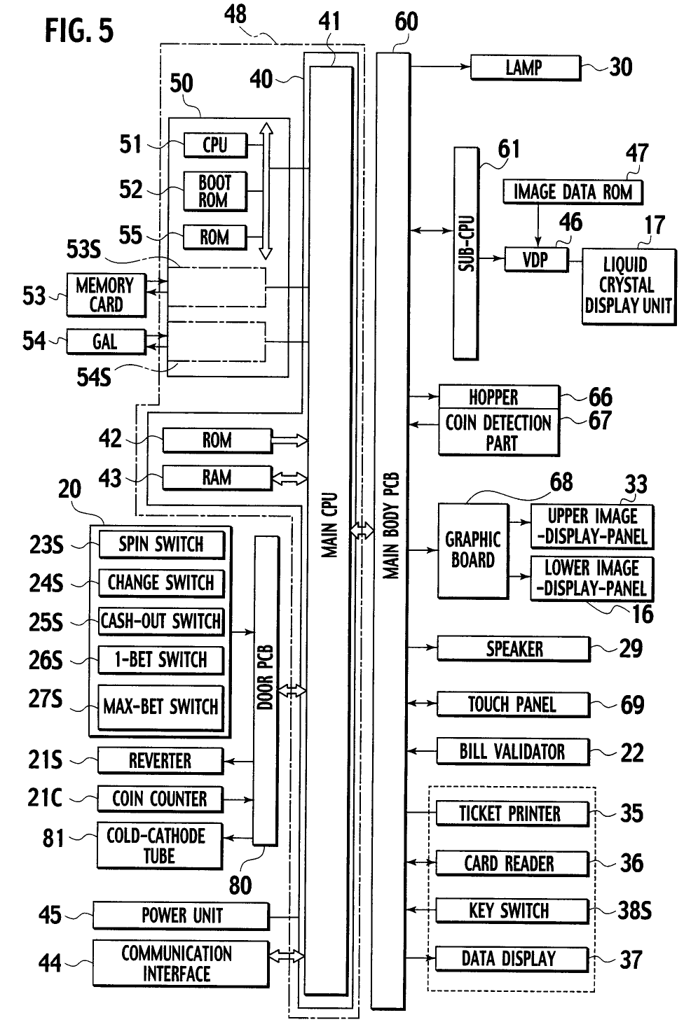

On a front surface of the lower image display panel 16, a touch panel 69 (see FIG. 5) is provided. The player can input various instructions by operating the touch panel 69.

Below the lower image display panel 16, provided are: a control panel 20 including a plurality of buttons 23 to 27 used by the player to input instructions related to a game process; the coin receiving port 21 for receiving coins into the cabinet 11; and a bill validator 22.

In the control panel 20, a spin button 23, a change button 24, a cash-out button 25, a 1-BET button 26 and a maximum-BET (MAX-BET) button 27 are provided. The spin button 23 is a button for inputting an instruction to start scrolling the symbols displayed in the display part 28. The change button 24 is a button used to request money exchange to a staff member at the game arcade. The cash-out button 25 is a button for inputting an instruction to pay out credited coins onto a coin tray 18 from a coin payout opening 19.

The 1-BET button 26 is a button for inputting an instruction to bet one of the credited coins on a game. The maximum-BET button 27 is a button for inputting an instruction to bet the maximum number (for example, 50) of coins that can be bet on one game out of the credited coins on the game.

The bill validator 22 validates whether or not bills are legitimate, and accepts the legitimate bills into the cabinet 11. The bill validator 22 may be configured to be able to read a bar-coded ticket 39 to be described later. On the front surface of a lower part of the main door 13, in other words, below the control panel 20, a belly glass 34 is provided, on which character images and the like of the slot machine 10 are drawn.

On a front surface of the top box 12, an upper image-display-panel 33 is provided. The upper image-display-panel 33 includes a liquid crystal panel, and displays, for example, effect images and images showing introduction of game contents and description of game rules.

In the top box 12, a speaker 29 for audio output and a lamp 30 are provided. Below the upper image-display panel 33, a ticket printer 35, a card reader 36, a data display 37 and a keypad 38 are provided. The ticket printer 35 prints a bar-code on a ticket, the bar-code having coded data such as the number of credits, time and date, and an identification number of the slot machine 10, and outputs the ticket as the bar-coded ticket 39. The player can use the bar-coded ticket 39 to play other slot machines or change the bar-coded ticket 39 for bills and the like at a cashier or the like in the game arcade.

The card reader 36 reads data from a smart card and writes data into the smart card. The smart card is a card carried by the player, and stores, for example, data for identifying the player and data on a history of games played by the player.

The data display 37 is formed of a fluorescent display or the like, and displays, for example, the data read by the card reader 36 and data inputted by the player using the keypad 38. The keypad 38 is used to input instructions or data for ticketing and the like.

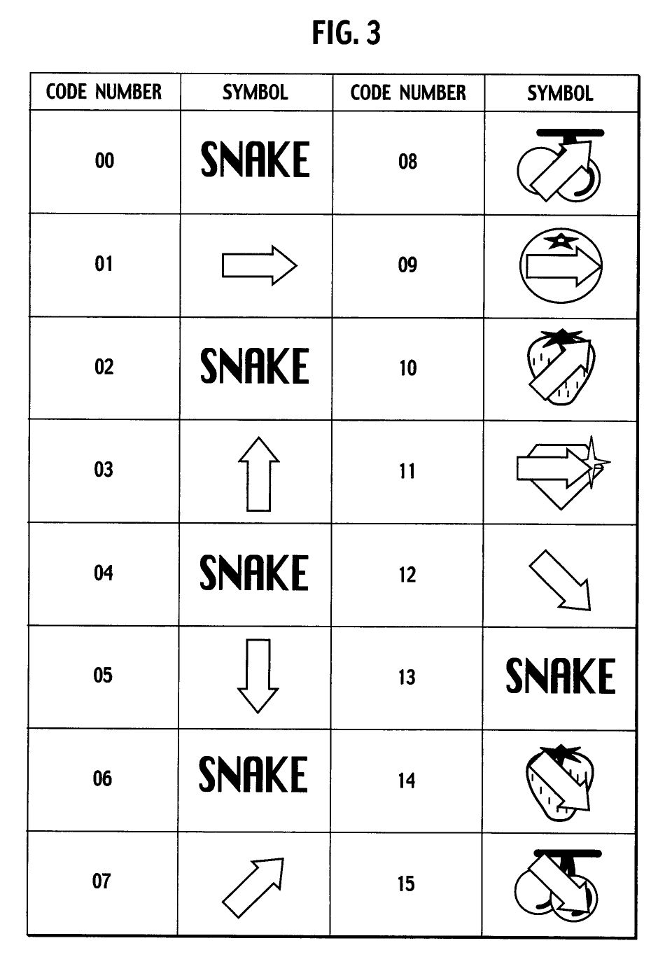

FIG. 3 is an explanatory view showing symbols scrolled in the respective display areas 28 provided in the liquid crystal display unit 17 in the cabinet 11. As shown in FIG. 3, for example, a total of 16 kinds of symbols each having one of the different code numbers “00” to “15” are set in the respective display areas 28. The respective symbols are randomly scrolled regardless of the code numbers.

As the symbols displayed in the respective display areas 28, snakes (trap symbols Z), five kinds of arrows (moving direction indicator symbols Y), two kinds of cherries each having a different kind of arrow (Y) superimposed thereon (symbols W related to payouts), an orange having one kind of arrow (Y) superimposed thereon (symbol W related to a payout), two kinds of strawberries each having a different kind of arrow (Y) superimposed thereon (symbols W related to payouts), and a diamond having one kind of arrow (Y) superimposed thereon (symbol W related to a payout) are set. Moreover, a payout table (see FIG. 4) is set as a table for determining payouts when the frog character image X has reached the goal display part 71.

Here, each of the code numbers of the arrow symbols which are the moving direction indicator symbols Y serves as a flag for the frog character image X to be superimposed and displayed on the symbol in the display area pointed by the arrow symbol. For example, the code number “07” indicates that the frog character image X is superimposed and displayed on the symbol in the display area 28 obliquely thereabove or the like at a predetermined timing.

FIG. 4 shows the payout table. In the payout table, the number of coins to be paid out per 1 BET is set according to the kinds and the number of symbols on the track when the frog character image X has reached the goal display part 71.

For example, in the case where there is no diamond or cherry symbol on the track of movement of the frog character image X when the frog character image X has reached the goal display part 71, in other words, the case where there are only the moving direction indicator symbols Y on the track of movement of the frog character image X, 2 coins are paid out per 1 BET. Moreover, for example, in the case where there is one diamond symbol on the track of movement of the frog character image X when the frog character image X has reached the goal display part 71, 10 coins are paid out per 1 BET. In addition, coins are paid out according to the number of symbols (for example, 1 coin per symbol) on the track of movement of the frog character image X. When there is more than one frog character image X that has reached the goal display part 71, payouts for all the frog character images X that have reached the goal display part 71 are added up.

FIG. 5 is a block diagram showing a control circuit in the slot machine 10 shown in FIG. 2. As shown in FIG. 5, the control circuit includes components such as a controller 48, a main body PCB (Printed Circuit Board) 60, a sub-CPU 61, a door PCB 80 and various switches and sensors. The controller 48 is formed of a mother board 40 and a gaming board 50.

The gaming board 50 includes the following: a CPU (Central Processing Unit) 51, a ROM 55, and a boot ROM 52, which are connected to each other through an internal bus; a card slot 53S compatible with a memory card 53; and an IC socket 54S compatible with a GAL (Generic Array Logic) 54.

The memory card 53 stores game programs and game system programs. The game programs include a stop-symbol determination program. The stop-symbol determination program is a program for determining symbols (code numbers corresponding to the symbols) to be stopped in the respective display areas 28a1 to 28e3 in 5 columns×3 rows. The stop-symbol determination program contains symbol weighted data corresponding to each of various payout rates (for example, 80%, 84% and 88%). The symbol weighted data is data showing a corresponding relationship between the code number of each symbol (see FIG. 3) and one or more random number values belonging to a predetermined numeric range (0 to 256) for each of the display areas 28a1 to 28e3 in 5 columns×3 rows.

The payout rate is set according to payout rate setting data outputted from the GAL 54. According to the symbol weighted data corresponding to the payout rate, stop symbols are determined.

The card slot 53S is formed so as to enable the memory card 53 to be inserted thereinto or removed therefrom, and is connected to the mother board 40 through an IDE bus. Hence, the kinds and contents of games played by use of the slot machine 10 can be changed by removing the memory card 53 from the card slot 53S, writing another game program and game system program into the memory card 53 and inserting the memory card 53 into the card slot 53S.

Besides the above, the game program contains a program related to a game process, a program related to overlapping display of the dynamic character image X, image data and sound data which are outputted during games, and the like.

The GAL 54 includes a plurality of input ports and output ports. Upon receipt of data through the input port, the GAL 54 outputs data corresponding to the inputted data from the output port. The data outputted from the output port is the payout rate setting data described above.

The IC socket 54S is formed so as to enable the GAL 54 to be attached thereto or detached therefrom, and is connected to the mother board 40 through a PCI bus. Hence, the payout rate setting data to be outputted from the GAL 54 can be changed by detaching the GAL 54 from the IC socket 54S, rewriting programs stored in the GAL 54, and attaching the GAL 54 to the IC socket 54S.

The CPU 51, the ROM 55, and the boot ROM 52, which are connected to each other through the internal bus, are connected to the mother board 40 through a PCI bus. The PCI bus transmits signals between the mother board 40 and the gaming board 50, and also supplies power from the mother board 40 to the gaming board 50. The ROM 55 stores country identification information and an authentication program. The boot ROM 52 stores a preliminary authentication program, a program (a boot code) for the CPU 51 to run the preliminary authentication program, and the like.

The authentication program is a program (alteration check program) for authenticating the game program and the game system program. Moreover, the authentication program is a program for checking and proving that the game program and the game system program have not been altered. Specifically, the authentication program is described according to procedures for authenticating the game program and the game system program. The preliminary authentication program is a program for authenticating the authentication program described above. Moreover, the preliminary authentication program is described according to procedures for proving that the authentication program to be authenticated has not been altered, in other words, for authenticating the authentication program.

The mother board 40 includes a main CPU 41, a ROM (Read Only Memory) 42, a RAM (Random Access Memory) 43 and a communication interface 44.

The main CPU 41 includes a function of controlling the entire slot machine 10. Particularly, the main CPU 41 performs control of displaying in the liquid crystal display unit 17 through the sub-CPU 61 the start display part 70 from which the dynamic character image X starts moving, the goal display part 71 to be reached by the dynamic character image X, the upper return-symbol display part 72 which returns to the display part 28 the dynamic character image X that has moved to above the display part 28, and the lower return-symbol display part 73 which returns to the display part 28 the dynamic character image X that has moved to below the display part 28. Moreover, the main CPU 41 performs: control of determining symbols to be stopped after the respective symbols displayed in the respective display areas 28 in the liquid crystal display unit 17 are scroll-displayed by the sub-CPU 61 when credits are bet and the spin button 23 is pressed; control of displaying the determined symbols in such a manner that the symbols are sequentially stopped at predetermined intervals for each of the columns of the display areas 28a1 to 28e3; and control of displaying the dynamic character image X so as to be superimposed on predetermined symbols every time the determined symbols are sequentially stopped at predetermined intervals for each of the columns of the display areas 28a1 to 28e3. As described later, the display of movement of the dynamic character image X is controlled so as to make the image move along the moving direction indicated by the moving direction indicator symbols Y.

When the dynamic character image X reaches the goal display part 71, the main CPU 41 determines a payout of credits by referring to the payout table shown in FIG. 4. In this event, determination is made so as to provide a payout of credits according to the kinds and the number of symbols on the track when the dynamic character image X has reached the goal display part 71.

The ROM 42 stores a program such as a BIOS (Basic Input/Output System) executed by the main CPU 41 and also stores data to be permanently used. When the BIOS is executed by the main CPU 41, the respective peripheral devices are initialized. Moreover, read processing through the gaming board 50 is started for the game program and the game system program which are stored in the memory card 53.

The RAM 43 stores data and programs used when the main CPU 41 performs processing.

The communication interface 44 is for communication with a host computer and the like provided in the game arcade through a communication line.

The main body PCB (Printed Circuit Board) 60 and the door PCB 80, which will be described later, are connected to the mother board 40 through USBs (Universal Serial Bus), respectively. A power unit 45 is connected to the mother board 40. When power is supplied from the power unit 45 to the mother board 40, the main CPU 41 in the mother board 40 is started. Moreover, the power is supplied to the gaming board 50 through the PCI bus to start the CPU 51.

A device or an apparatus which generates an input signal to be inputted to the main CPU 41 and a device or an apparatus having operations controlled by a control signal outputted from the main CPU 41 are connected to the main body PCB 60 and the door PCB 80. The main CPU 41 performs arithmetic processing by executing the game program and the game system program, which are stored in the RAM 43, based on the input signal inputted to the main CPU 41, and stores results thereof in the RAM 43. The main CPU 41 also performs processing of transmitting the control signal to the respective devices or apparatuses as control processing for the respective devices or apparatuses.

The lamp 30, the sub-CPU 61, a hopper 66, a coin detection part 67, the graphic board 68, the speaker 29, the touch panel 69, the bill validator 22, the ticket printer 35, the card reader 36, a key switch 38S and the data display 37 are connected to the main body PCB 60.

Upon receipt of a command from the main CPU 41, the sub-CPU 61 performs control of scrolling and stopping the symbols displayed in 5 columns×3 rows, a total of 15 display areas 28a1 to 28e3 set in the liquid crystal display unit 17. Moreover, the sub-CPU 61 is connected to a VDP (Video Display Processor) 46.

Under the control of the sub-CPU 61, the VDP 46 reads image data of the symbols stored in an image data ROM 47, generates a scroll image to be displayed on the liquid crystal display unit 17, and then outputs the scroll image to the liquid crystal display unit 17. Under the control of the sub-CPU 61, the VDP 46 reads, for example, a frog character image X stored in the image data ROM 47, displays the frog character image X so as to be superimposed on respective symbols according to the moving direction indicator symbols, and informs the player of a moving state of the frog character image X.

The hopper 66 is placed in the cabinet 11 and pays out a predetermined number of coins from the coin payout opening 19 onto the coin tray 18 based on a control signal outputted from the main CPU 41. The coin detection part 67 is provided inside the coin payout opening 19 and outputs an input signal to the main CPU 41 when detecting that the predetermined number of coins are paid out from the coin payout opening 19.

The graphic board 68 controls display of images other than the symbols displayed in the display areas 28, the display of images shown on the upper and lower image-display-panels 33 and 16 according to a control signal outputted from the main CPU 41. The credit number display part 31 in the lower image-display-panel 16 displays the number of credits stored in the RAM 43. Moreover, the payout number display part 32 in the lower image-display-panel 16 displays the number of coins to be paid out. The graphic board 68 includes: a VDP which generates image data according to a control signal outputted from the main CPU 41; a video RAM which temporarily stores the image data generated by the VDP; and the like.

The bill validator 22 reads images of bills and accepts legitimate bills into the cabinet 11. Upon acceptance of the legitimate bills, the bill validator 22 outputs an input signal to the main CPU 41 according to the amount of the bills. Thereafter, the main CPU 41 stores in the RAM 43 the number of credits corresponding to the amount of the bills transmitted by the input signal.

The ticket printer 35 prints a bar-code on a ticket according to a control signal outputted from the main CPU 41, the bar-code having coded data such as the number of credits stored in the RAM 43, time and date, and the identification number of the slot machine 10, and then outputs the ticket as the bar-coded ticket 39.

The card reader 36 reads data from a smart card and transmits the data to the main CPU 41, and also writes data into the smart card according to a control signal from the main CPU 41. The key switch 38S is provided in the keypad 38 and outputs an input signal to the main CPU 41 when the keypad 38 is operated by the player.

According to a control signal outputted from the main CPU 41, the data display 37 displays the data read by the card reader 36 and data inputted by the player using the keypad 38.

The control panel 20, a reverter 21S, a coin counter 21C and a cold cathode tube 81 are connected to the door PCB 80. In the control panel 20, a spin switch 23S corresponding to the spin button 23, a change switch 24S corresponding to the change button 24, a cash-out switch 25S corresponding to the cash-out button 25, a 1-BET switch 26S corresponding to the 1-BET button 26 and a maximum-BET (MAX-BET) switch 27S corresponding to the maximum-BET button 27 are provided. Each of the switches 23S to 27S outputs an input signal to the main CPU 41 when the corresponding buttons 23 to 27 are operated by the player.

The coin counter 21C is provided inside the coin receiving port 21 and validates whether or not coins thrown into the coin receiving port 21 by the player are legitimate. Those other than the legitimate coins are discharged from the coin payout opening 19. Upon detection of the legitimate coins, the coin counter 21C outputs an input signal to the main CPU 41.

The reverter 21S is operated according to a control signal outputted from the main CPU 41, and allocates the coins recognized as the legitimate coins by the coin counter 21C to a cash box (not shown) provided in the slot machine 10 or to the hopper 66. Specifically, when the hopper 66 is filled with coins, the legitimate coins are allocated to the cash box by the reverter 21S. Meanwhile, when the hopper 66 is not filled with coins, the legitimate coins are allocated to the hopper 66.

The cold cathode tube 81 functions as a backlight provided on a back side of the upper and lower image-display-panels 33 and 16, and is lighted according to a control signal outputted from the main CPU 41.

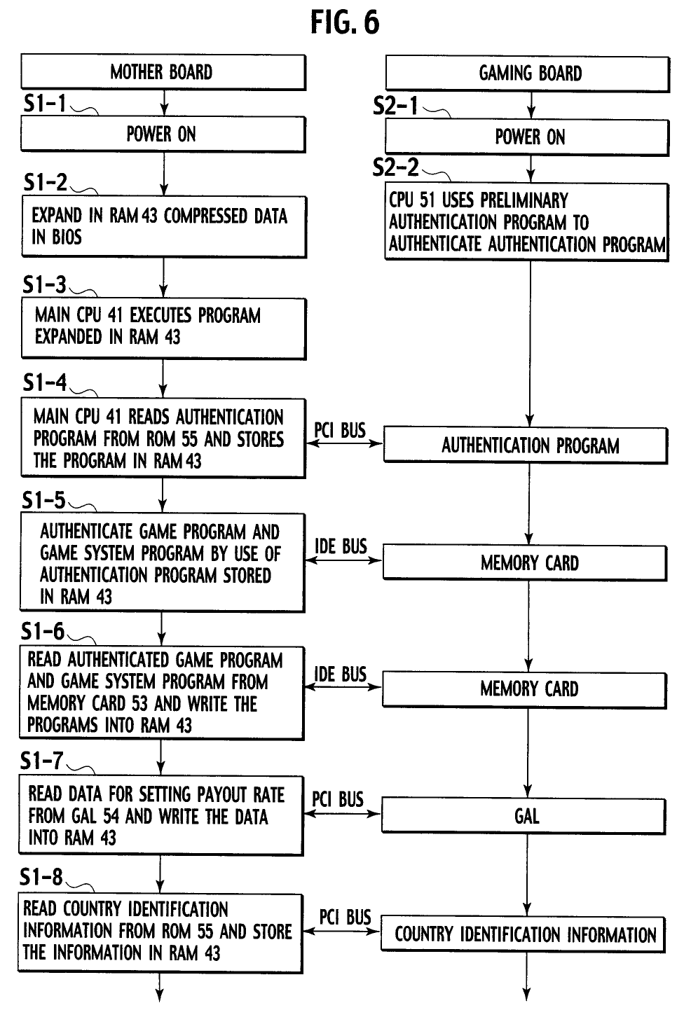

Next, specific processing executed in the slot machine 10 will be described. FIG. 6 is a flowchart showing procedures (processing of Step S100 shown in FIG. 1) of authentication and read processing for the game program and the game system program executed by the mother board 40 and the gaming board 50 which are shown in FIG. 5. The memory card 53 is inserted into the card slot 53S in the gaming board 50, and the GAL 54 is attached to the IC socket 54S.

First, when a power switch is turned on in the power unit 45, the mother board 40 and the gaming board 50 are activated (Steps S1-1 and S2-1). When the mother board 40 and the gaming board 50 are activated, different processings are performed in parallel with each other. Specifically, in the gaming board 50, the CPU 51 reads a preliminary authentication program stored in the boot ROM 52, and performs, according to the read preliminary authentication program, preliminary authentication of previously checking and proving that an authentication program has not been altered before the program is taken into the mother board 40 (Step S2-2).

Meanwhile, in the mother board 40, the main CPU 41 executes a BIOS stored in the ROM 42 and expands compressed data, which is included in the BIOS, in the RAM 43 (Step S1-2). Thereafter, the main CPU 41 diagnoses and initializes various peripheral devices by executing the BIOS expanded in the RAM 43 (Step S1-3).

Subsequently, since the ROM 55 in the gaming board 50 is connected to the main CPU 41 through the PCI bus, the main CPU 41 reads an authentication program stored in the ROM 55. Furthermore, the main CPU 41 performs processing of storing the read authentication program in the RAM 43 (Step S1-4).

Next, the main CPU 41 accesses the memory card 53 attached to the card slot 53S through the IDE bus. Thereafter, the main CPU 41 reads a game program and a game system program which are stored in the memory card 53.

Thereafter, according to the authentication program stored in the RAM 43, the main CPU 41 performs authentication of checking and proving that the read game program and game system program have not been altered (Step S1-5).

When the above authentication processing is normally finished, the main CPU 41 stores the authenticated game program and game system program in the RAM 43 (Step S1-6). Next, the main CPU 41 accesses the GAL 54 attached to the IC socket 54S through the PCI bus, reads payout rate setting data from the GAL 54, and stores the data in the RAM 43 (Step S1-7). Thereafter, the main CPU 41 reads country identification information stored in the ROM 55 in the gaming board 50 through the PCI bus, and stores the read country identification information in the RAM 43 (Step S1-8).

After carrying out the above processing, the main CPU 41 in the controller 48 executes a basic game described below by sequentially reading and executing the game program and the game system program.

After the authentication and read processing shown in FIG. 6 is executed, the main CPU 41 performs processing of executing the basic game. FIG. 7 is a flowchart showing specific procedures for basic game execution processing of Step S200 shown in FIG. 1. Here, description will be given by taking as an example an embodiment different from that described with reference to FIG. 1. Specifically, in the case of the embodiment shown in FIG. 1, the dynamic character image X is moved after rearrangement of the symbols in all the columns 28a to 28e is completed. By contrast, in the case of the embodiment shown in FIG. 7, a dynamic character image X starts moving when rearrangement of symbols in predetermined columns 28a and 28b is completed.

In the basic game execution processing, first, the main CPU 41 determines whether or not coins are bet (Step S11). In this processing, the main CPU 41 determines whether or not an input signal outputted from the 1-BET switch 26S when the 1-BET button 26 is pressed is received or whether or not an input signal outputted from the maximum-BET switch 27S when the maximum-BET button 27 is pressed is received. When it is determined that no coins are bet, the processing returns to Step S11.

Meanwhile, when it is determined in Step S11 that the coins are bet, the main CPU 41 performs processing of reducing the number of credits stored in the RAM 43 according to the number of the coins bet (Step S12). Note that, when the number of the coins bet is larger than the number of credits stored in the RAM 43, the processing returns to Step S11 without performing the processing of reducing the number of credits stored in the RAM 43. Moreover, when the number of the coins bet exceeds the upper limit (50 in this embodiment) that can be bet in one game, the processing advances to Step S13 without performing the processing of reducing the number of credits stored in the RAM 43.

Next, the main CPU 41 determines whether or not the spin button 23 is turned on (Step S13). In this processing, the main CPU 41 determines whether or not an input signal outputted from the spin switch 23S when the spin button 23 is turned on is received.

When it is determined that the spin button 23 is not turned on, the processing returns to Step S11. Note that, in the case where the spin button 23 is not turned on (for example, the case where an instruction to finish the game is inputted without turning on the spin button 23), the main CPU 41 cancels a result of reduction in Step S12.

In this embodiment, description will be given of the case where, after the coins are bet (Step S11), the processing of reducing the number of credits (Step S12) is executed before it is determined whether or not the spin button 23 is turned on (Step S13). However, the present invention is not limited to the above example. For example, the present invention may also be applied to the case where, after the coins are bet (Step S11), it is determined whether or not the spin button 23 is turned on (Step S13), and, when it is determined that the spin button 23 is turned on (YES in Step S13), the processing of reducing the number of credits (Step S12) is executed.

Subsequently, when it is determined in Step S13 shown in FIG. 7 that the spin button 23 is turned on, the main CPU 41 performs processing of scroll-displaying the symbols displayed in the respective display areas 28a1 to 28e3 through the sub-CPU 61 (Step S14). Here, the start display part 70 from which the dynamic character image X starts moving is displayed adjacent to the left side of the rectangular display part 28. The goal display part 71 to be reached by the dynamic character image X is displayed adjacent to the right side of the rectangular display part 28. The upper return-symbol display part 72 which returns to the display part 28 the dynamic character image X that has moved to above the display part 28 is displayed adjacent to the upper side of the rectangular display part 28. The lower return-symbol display part 73 which returns to the display part 28 the dynamic character image X that has moved to below the display part 28 is displayed adjacent to the lower side of the rectangular display part 28 (see FIG. 11).

Specifically, for example, here, as shown in FIG. 11, in the start display part 70, three moving direction indicator symbols Y pointing to the right are displayed, as the moving direction indicator symbols (first symbols) Y, so as to correspond to the three rows in the display part 28. Moreover, on the three moving direction indicator symbols Y, frog dynamic character images X are superimposed and displayed, respectively.

Moreover, in the upper return-symbol display part 72, six display areas 72a to 72f are provided, each having the same size as that of each of the display areas 28a1 to 28e3 in the display part 28. In the display areas 72a to 72f, moving direction indicator symbols (fourth symbols) Y pointing obliquely downward for returning the dynamic character image X into the display part 28 and snake symbols (third symbols) Z are alternately fixed and displayed.

Furthermore, also in the lower return-symbol display part 73, six display areas 73a to 73f are provided, each having the same size as that of each of the display areas 28a1 to 28e3 in the display part 28. In the display areas 73a to 73f, moving direction indicator symbols (fourth symbols) Y pointing obliquely upward for returning the dynamic character image X into the display part 28 and snake symbols (third symbols) Z are alternately fixed and displayed.

Next, the main CPU 41 first performs processing of stopping the symbols in the leftmost column 28a (Step S15). In this symbol stop processing, the main CPU 41 determines and stops the symbols to be stopped in the three display areas 28a1 to 28a3 in the leftmost column 28a by executing the stop-symbol determination program stored in the RAM 43. Here, a moving direction indicator symbol Y pointing obliquely upward, a cherry with a moving direction indicator symbol pointing obliquely downward (second symbol) W and a moving direction indicator symbol Y pointing obliquely upward are stop-displayed in the display areas 28a1 to 28a3 (see FIG. 10).

Next, the main CPU 41 performs processing of stopping the symbols in the column 28b (Step S16). In this symbol stop processing, the main CPU 41 determines and stops the symbols to be stopped in the three display areas 28b1 to 28b3 in the column 28b by executing the stop-symbol determination program stored in the RAM 43. Here, a snake symbol Z, a moving direction indicator symbol Y pointing obliquely upward and a strawberry with a moving direction indicator symbol pointing obliquely downward (second symbol) W are stop-displayed in the display areas 28b1 to 28b3 (see FIG. 10).

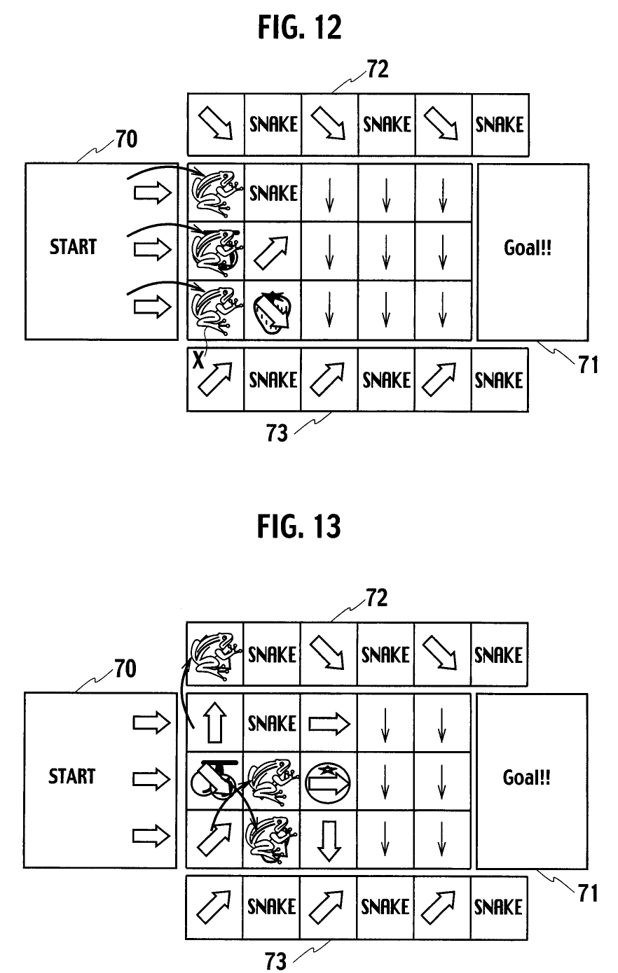

Next, the main CPU 41 performs display processing so as to move the three frog dynamic character images X to the stopped symbols in the leftmost column 28a from the start display part 70 when the symbols in the column 28b are stopped (Step S17). Specifically, in this embodiment, as shown in FIG. 12, the three frog character images as a plurality of dynamic character images X disappear from the start display part 70 when the symbols in the column 28b are stopped. Thereafter, the frog character images are superimposed and displayed on the symbols stopped in the display areas 28a1 to 28a3 in the leftmost column according to the moving direction indicator symbols Y in the start display part 70. Thus, the three frog character images appear to be moved in the direction indicated by the arrows, which are the moving direction indicator symbols Y, to the symbols in the display areas 28a1 to 28a3 in the leftmost column 28a from the start display part 70 when the symbols in the column 28b are stopped. Here, the main CPU 41 detects where in the column 28a the frog character images X should be moved and displayed using flags indicating the directions of the moving direction indicator symbols Y on which the frog character images X are superimposed and displayed. Specifically, for example, since the top frog character image X in the start display part 70 is superimposed and displayed on the moving direction indicator symbol Y pointing to the right, the frog character image X may be superimposed and displayed on the symbol in the display area 28a1 on the right. Here, the display areas 28a1 to 28a3 of the symbols on which the dynamic character images X are superimposed and displayed are displayed brighter than the other display areas by use of a backlight and the like, for example. Accordingly, a different display mode is set for the display areas so as to be easily recognizable to the player. As means for setting the different display mode, various means are conceivable, such as display in special colors, other than the backlight.

The display operation of making the frog character images X disappear from the symbols or the like may be achieved by performing display control so as to switch from a display state where the frog character images X are superimposed and displayed on the symbols or the like to a display state where only the symbols or the like are displayed. The display operation of displaying the frog character images X so as to be superimposed on the symbols or the like may be achieved by performing display control so as to switch from the display state where only the symbols or the like are displayed to the display state where the frog character images X are superimposed and displayed on the symbols or the like. In this case, symbols having the frog character images X superimposed on the respective symbols shown in FIG. 3 are prepared and respective code numbers thereof are prepared (for example, 01A and 01B in the case of the code number 01).

Next, the main CPU 41 performs processing of stopping the symbols in the column 28c (Step S18). In this symbol stop processing, the main CPU 41 determines and stops the symbols to be stopped in the three display areas 28c1 to 28c3 in the column 28c by executing the stop-symbol determination program stored in the RAM 43. Here, a moving direction indicator symbol Y pointing to the right, an orange symbol with a moving direction indicator symbol pointing to the right (second symbol) W and a moving direction indicator symbol Y pointing downward are stop-displayed in the display areas 28c1 to 28c3 (see FIG. 13).

Next, the main CPU 41 performs display processing so as to move the frog dynamic character images X to the stopped symbols in the column 28b from the column 28a (Step S19). Specifically, in this embodiment, as shown in FIG. 13, the three frog character images disappear from the column 28a when the symbols in the column 28c are stopped. Thereafter, the frog character images are superimposed and displayed on the symbol in the display area 72a in the upper return-symbol display part 72 and on the symbols stopped in the display areas 28b2 and 28b3 in the column 28b according to the directions indicated by the moving direction indicator symbols Y stopped in the display areas 28a1 to 28a3 in the column 28a. Here, the display areas 72a, 28b2 and 28b3 of the symbols on which the dynamic character images X are superimposed and displayed are displayed brighter than the other display areas by use of the backlight and the like, for example. Accordingly, a different display mode is set for the display areas so as to be easily recognizable to the player.

Thus, the three frog character images appear to be moved in the directions indicated by the arrows to the display area 72a in the upper return-symbol display part 72 and to the display areas 28b2 and 28b3 in the column 28b from the leftmost column 28a when the symbols in the column 28c are stopped.

Next, the main CPU 41 performs processing of stopping the symbols in the column 28d (Step S20). In this symbol stop processing, the main CPU 41 determines and stops the symbols to be stopped in the three display areas 28d1 to 28d3 in the column 28d by executing the stop-symbol determination program stored in the RAM 43. Here, a cherry symbol with a moving direction indicator symbol pointing obliquely upward (second symbol) W, a snake symbol Z and a moving direction indicator symbol Y pointing obliquely upward are stop-displayed in the display areas 28d1 to 28d3 (see FIG. 10).

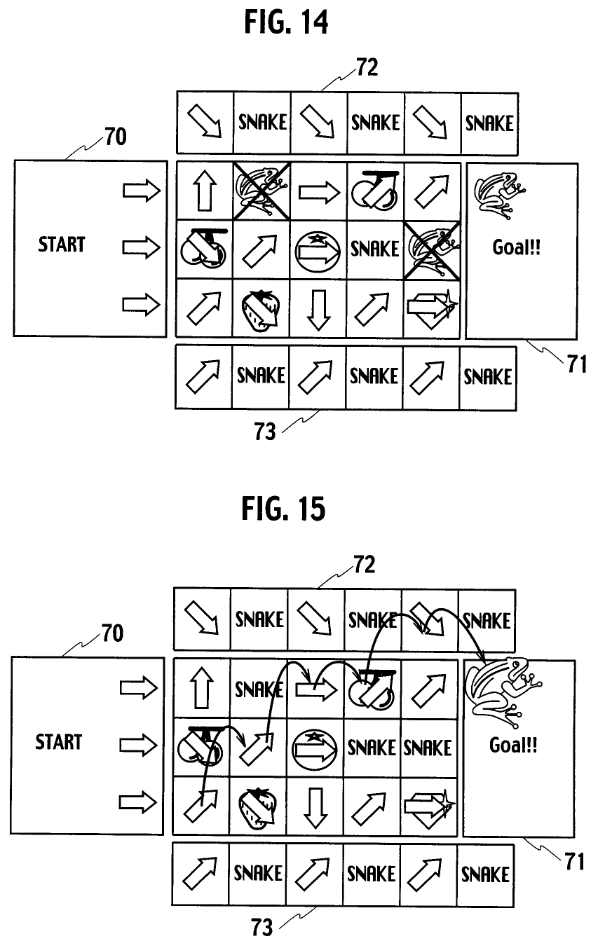

Next, the main CPU 41 performs display processing so as to move the frog dynamic character images X to the stopped symbols in the column 28c from the column 28b (Step S21). Specifically, in this embodiment, the two frog character images X disappear from the column 28b when the symbols in the column 28c are stopped. Thereafter, the frog character images are superimposed and displayed on the stopped symbol in the display area 28c1 in the column 28c and on the symbol in the display area 73c in the lower return-symbol display part 73. Here, the remaining one frog character image X that has been displayed in the display area 72a in the upper return-symbol display part 72 is returned to the display area 28b1 in the column 28b and superimposed and displayed on the symbol therein according to the direction indicated by the moving direction indicator symbol Y. However, since the snake symbol Z is stop-displayed in the display area 28b1, a “×” mark is also superimposed and displayed on the frog character image X (see FIG. 14). Here, the display areas 28c1 and 73c of the symbols on which the dynamic character images X are superimposed and displayed are displayed brighter than the other display areas by use of the backlight and the like, for example. Accordingly, a different display mode is set for the display areas so as to be easily recognizable to the player.

Thus, the two frog character images appear to be moved in the directions indicated by the arrows to the display area 28c1 in the column 28c and to the display area 73c in the lower return-symbol display part 73 from the column 28b when the symbols in the column 28c are stopped. Moreover, the remaining one frog character image X appears to be eaten to death by the snake after being returned to the display area 28b1 in the column 28b from the display area 72a in the upper return-symbol display part 72.

Next, the main CPU 41 performs processing of stopping the symbols in the column 28e (Step S22). In this symbol stop processing, the main CPU 41 determines and stops the symbols to be stopped in the three display areas 28e1 to 28e3 in the column 28e by executing the stop-symbol determination program stored in the RAM 43. Here, a moving direction indicator symbol Y pointing obliquely upward, a snake symbol Z and a diamond symbol with a moving direction indicator symbol pointing to the right (second symbol) W are stop-displayed in the display areas 28e1 to 28e3 (see FIG. 14).

Next, the main CPU 41 performs display processing so as to move the frog dynamic character images X to the stopped symbols in the columns 28d and 28e and then to the goal display part 71 from the column 28c (Step S23). Specifically, in this embodiment, as shown in FIG. 14, the two frog character images X disappear from the display area 28c1 in the column 28c and from the display area 73c in the lower return-symbol display part 73 when the symbols in the column 28e are stopped. Thereafter, the frog character images are superimposed and displayed on the symbols in the display areas 28d1 and 28d3. Subsequently, the frog character images disappear from the display areas 28d1 and 28d3 in the column 28d, and are superimposed and displayed on the symbol in the display area 72e in the upper return-symbol display part 72 and on the symbol in the display area 28e2 in the column 28e. Note that, since the snake symbol is stop-displayed in the display area 28e2, a “x” mark is also superimposed and displayed on the frog character image. Thereafter, finally, the one frog character image disappears from the display area 72e in the upper return-symbol display part 72, and is displayed in the goal display part 71 as the goal. Here, the display areas 28d1, 28d3, 72e and 28e2 of the symbols on which the dynamic character images X are superimposed and displayed are displayed brighter than the other display areas by use of the backlight and the like, for example. Accordingly, a different display mode is set for the display areas so as to be easily recognizable to the player.

Thus, one of the frog character images appears to be eaten to death by the snake after being moved to the display area 28e2 from the display area 28d3. Moreover, the remaining one frog character image X appears to be moved to the goal display part 71 as the goal from the display area 72e in the upper return-symbol display part 72.

Thereafter, the main CPU 41 determines whether or not the frog character image X has reached the goal display part (goal) 71 to be reached by the frog character image X after the symbols in the last column 28e are stopped (Step S24).

Next, when the frog character image X has reached the goal display part (goal) 71 (YES in Step S24), coins are paid out according to the number of the frog character images X that have reached the goal display part (goal) 71 and the number of the symbols on which the frog character images X are superimposed and displayed. Moreover, coins are paid out according to the type of winning combination (Step S25). At this point, only the display areas on the track of movement of the frog character image X that has reached the goal display part (goal) 71 may be brightly displayed.

Here, as shown in FIG. 15, since there is one cherry symbol on the track of movement of the frog character image X, 4 coins are paid out per 1 BET (see FIG. 4). Hence, the track of movement of the frog character image X serves as a payline. In the case where a symbol (symbol W) to be a bonus does not exist on the track of movement of the frog character image X, 2 coins are paid out per 1 BET (see FIG. 4).

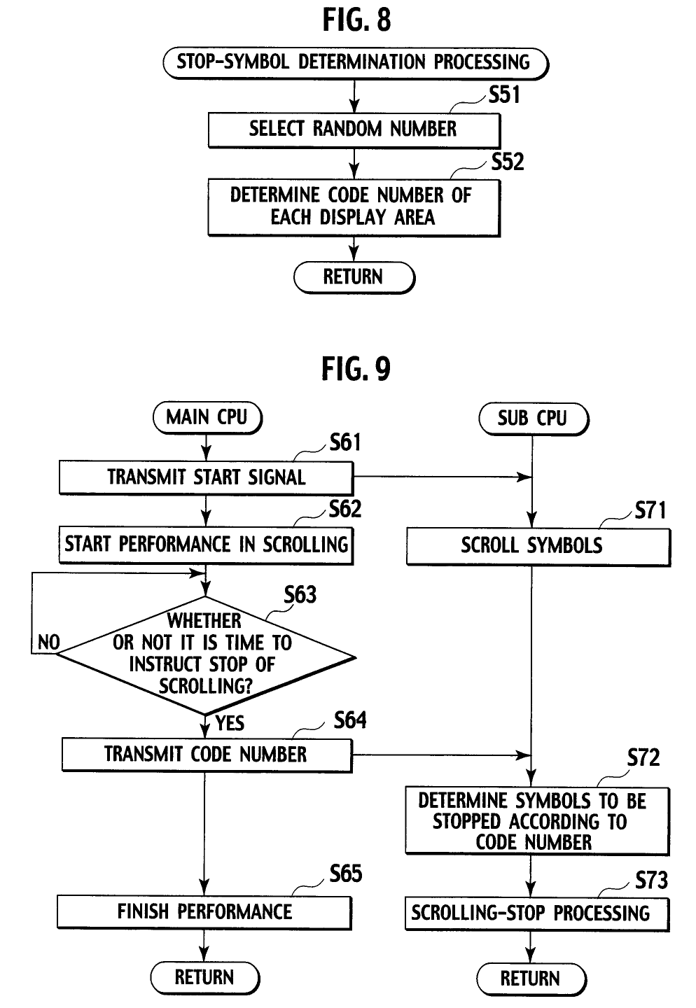

Next, with reference to a flowchart shown in FIG. 8, description will be given of the stop symbol determination processing in Step S15 shown in FIG. 7.

FIG. 8 is a flowchart showing procedures of the stop symbol determination processing in Step S15 shown in FIG. 7. This processing is performed by the main CPU 41 executing the stop-symbol determination program stored in the RAM 43.

First, the main CPU 41 selects random number values corresponding to the respective display areas 28e1 to 28e3 in the rightmost column from a numeric range of 0 to 255 by executing a random number generation program included in the stop-symbol determination program (Step S51).

Next, the main CPU 41 determines the code numbers (see FIG. 3) of the respective display areas 28e1 to 28e3 using the selected random number values by referring to symbol weighted data corresponding to the payout rate setting data outputted from the GAL 54 and stored in the RAM 43 (Step S52).

FIG. 9 is a flowchart showing symbol-scroll control processing in Step S16 shown in FIG. 7. This processing is executed between the main CPU 41 and the sub-CPU 61.

First, the main CPU 41 transmits to the sub-CPU 61 a start signal to start scroll-display of the symbols in the display areas 28e1 to 28e3 in the rightmost column among the display areas 28 set in the liquid crystal display unit 17 (Step S61). Upon receipt of the start signal from the main CPU 41, the sub-CPU 61 outputs a symbol-scroll display command to the VDP 46. Thereafter, the VDP 46 reads symbol image data stored in the image data ROM 47, and scrolls the symbols in the display areas 28e1 to 28e3 in the rightmost column in the liquid crystal display unit 17 (Step S71). Thus, scrolling of the symbols is started in the respective display areas 28 in the rightmost column.

After transmitting the start signal to the sub-CPU 61 in Step S61 shown in FIG. 9, the main CPU 41 executes an effect in scrolling of the symbols (Step S62). This processing is processing of displaying images on the lower image-display-panel 16, outputting sounds from the speaker 29, and the like for a period of time (for example, 3 seconds) determined according to a result of the stop symbol determination processing (Step S15 in FIG. 7) and the like.

Next, the main CPU 41 determines whether or not it is time to instruct stop of the scrolling (Step S63 in FIG. 9).

When it is determined in the processing of Step S63 that it is not the time to instruct stop of the scrolling, the processing returns to Step S63, and the effect in scrolling is continued. On the other hand, when it is determined in the processing of Step S63 that it is the time to instruct stop of the scrolling, the main CPU 41 transmits the code numbers of the symbols stored in the RAM 43 to the sub-CPU 61 (Step S64). Upon receipt of the code numbers of the symbols from the main CPU 41, the sub-CPU 61 determines the symbols to be stopped so as to correspond to the code numbers (Step S72).

Thereafter, processing of stopping the scrolling is performed, and the symbols are stop-displayed in the respective display areas 28 (Step S73). Moreover, the processing of displaying the effect image by the main CPU 41 is finished (Step S65).

Next, with reference to FIGS. 10 to 15, examples of display on the liquid crystal display unit 17 will be described.

FIG. 10 is a view showing positions of the respective display parts 28 and 70 to 73 in the liquid crystal display unit 17, and also showing the stopped symbols in the respective display areas 28a1 to 28e3 in this embodiment.

FIG. 11 is a view showing a state where the dynamic character images X are positioned in the start display part 70, and the symbols are scroll-displayed in the display part 28.

FIG. 12 is a view showing a state where the symbols in the column 28b are stopped, and the dynamic character images X are moved to the stopped symbols in the column 28a.

FIG. 13 is a view showing a state where the symbols in the column 28c are stopped and the dynamic character images X are moved to the stopped symbols in the column 28b.

FIG. 14 is a view showing a state where the symbols in the column 28e are stopped, and the dynamic character image X has reached the goal display part 71.

FIG. 15 is a view showing the track of movement of the dynamic character image X.

As described above, in the slot machine according to this embodiment, the dynamic character image X is displayed so as to reach the goal display part 71 after moving on the moving direction indicator symbols Y displayed in the display areas 28 from the start display part 70 on the liquid crystal display unit 17 in the step of rearranging the plurality of symbols in the respective display areas. When any of the dynamic character images X has reached the goal display part 71, a payout to the player is set according to the number of the dynamic character images X that have reached the goal display part 71, the number of symbols on the track of movement of the dynamic character image X that has reached the goal display part 71, and the number and types of symbols (winning combination) on the track of movement of the dynamic character image X that has reached the goal display part 71. Thus, a highly creative form of game as described above is provided. The player can be allowed to have high expectations, wondering whether or not the dynamic character image X will reach the goal display part 71 while following the movement of the dynamic character image X with his/her eyes.

Moreover, the plurality of symbols to be rearranged include the moving direction indicator symbols Y indicating the moving directions of the dynamic character image X and the trap symbols Z which stop the movement of the dynamic character image X. Thus, it is possible to further enhance the expectations of the player wondering in which direction the predetermined character image is to be moved.

In the slot machine according to the embodiment of the present invention, after the plurality of symbols are rearranged in the plurality of display areas provided in the matrix pattern or in the process until the rearrangement is completed, payouts are set using the number and combinations of the symbols on which the character image moving on the display areas are superimposed and displayed or using the number of the character images that have reached the goal display part. Thus, it is possible to allow the player to have much higher expectations about the payout compared with the conventional slot machine.

The slot machine according to the embodiment of the present invention has been described above. However, the invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein. In this embodiment, one kind of character image, the frog character image X is used, for example, as the dynamic character image X that is the predetermined character image. However, several kinds of character images may be used as predetermined character images and simultaneously displayed. In such a case, in addition to setting of payouts in this embodiment, setting of payouts according to the kinds of the predetermined character images may be executed. Specifically, a payout amount may be set to vary according to the kinds of the predetermined character images.

Moreover, the effects described in the embodiment of the present invention are only a list of optimum effects achieved by the present invention. Hence, the effects of the present invention are not limited to those described in the embodiment of the present invention.

What is claimed is:

1. A slot machine comprising:
a display having a rectangular display part in which a plurality of display areas are provided in a matrix pattern, and in which one of a plurality of symbols is arranged or rearranged in each of the plurality of display areas, and capable of displaying in the display part a character image moving across the plurality of display areas; and
a controller configured to
(a) automatically rearrange the symbols in at least some of the plurality of display areas,
(b) display the character image moving across the plurality of display areas when the rearrangement is at least partially completed, and
(c) set a payout according to one of a number and a combination of the symbols displayed on a track of movement of the character image.

2. A slot machine comprising:
a display in which at least the following five display parts can be formed, including
a display part having a rectangular shape, in which a plurality of display areas are provided in a matrix pattern, and in which one of a plurality of symbols is arranged or rearranged in each of the display areas,
a start display part and a goal display part which are positioned adjacent to one of two opposite sides of the display part, the start display part in which a character image before movement is arranged, the goal display part being a goal to be reached by the character image having started to move from the start display part, and
an upper return display part and a lower return display part which are positioned adjacent to the other two sides of the display part, the sides being adjacent to neither the start display part nor the goal display part, and in which fourth symbols are arranged, the fourth symbols indicating moving directions of the character image to the display part for returning the character image into the display part when the character image moving in the display part has moved to the outside of the other two sides,
wherein the plurality of symbols displayed in the plurality of display areas include: first symbols indicating moving directions of the character image; second symbols related to payouts; and third symbols stopping movement of the character image; and
a controller configured to
(a) randomly and automatically rearrange any of the first, second and third symbols in each of the display areas,
(b) start the character image to move from the start display part to the goal display part through the display part along the first symbols in any one of cases where rearrangement of the symbols is all completed and where rearrangement of the symbols in the display areas adjacent to the start display part is completed,
(c) return the character image into the display part along the fourth symbols when the character image moving in the display part has moved to the upper return display part or the lower return display part from the other two sides of the display part, and
(d) set a payout according to one of a number and a combination of the symbols displayed on a track of movement of the character image.

3. The slot machine according to claim 2, wherein the second symbols include the first symbols.

4. A method for playing a slot machine, comprising the steps of
(a) rearranging, by a controller, a plurality of symbols in a rectangular display part in which a plurality of display areas are provided in a matrix pattern, and in which one of the plurality of symbols is arranged or rearranged in each of the display areas, on a display;
(b) displaying, by the controller, a character image moving across the plurality of display areas when the rearrangement is at least partially completed; and
(c) setting, by the controller, a payout according to one of a number and a combination of the symbols displayed on a track of movement of the character image.

5. A method for playing a slot machine, comprising the steps of:
(a) forming, by a controller, at least the following five display parts on a display, including
a display part having a rectangular shape, in which a plurality of display areas are provided in a matrix pattern, and in which one of a plurality of symbols is arranged or rearranged in each of the display areas,
a start display part and a goal display part which are positioned adjacent to one of two opposite sides of the display part, the start display part in which a character image before movement is arranged, the goal display part being a goal to be reached by the character image having started to move from the start display part, and
an upper return display part and a lower return display part which are positioned adjacent to the other two sides of the display part, the sides being adjacent to neither the start display part nor the goal display part, and in which fourth symbols are arranged, the fourth symbols indicating moving directions of the character image to the display part for returning the character image into the display part when the character image moving in the display part has moved to the outside of the other two sides;
(b) randomly and automatically rearranging, by the controller, in the respective display areas in the display part, any of first, second and third symbols included in the plurality of symbols displayed in the plurality of display areas, the first symbols indicating moving directions of the character image, the second symbols related to payouts and the third symbols stopping movement of the character image;
(c) starting, by the controller, the character image to move from the start display part to the goal display part through the display part along the first symbols in any one of cases where rearrangement of the symbols is all completed and where rearrangement of the symbols in the display areas adjacent to the start display part is completed;
(d) returning, by the controller, the character image into the display part along the fourth symbols when the character image moving in the display part has moved to the upper return display part or the lower return display part from the other two sides of the display part; and
(e) setting, by the controller, a payout according to one of a number and a combination of the symbols displayed on a track of movement of the character image.

6. The method according to claim 5, wherein the second symbols include the first symbols.
